(19) United States
(12) Patent Application Publication
(10) Pub. No.: US 2013/0024334 A1
(43) Pub. Date: Jan. 24, 2013

(54) Personal biometric authentication system for secure timekeeping

(71) Applicant: Douglas Everett Kozlay, Timonium, MD (US)

(72) Inventor: Douglas Everett Kozlay, Timonium, MD (US)

(21) Appl. No.: 13/135,557

(22) Filed: Jul. 8, 2011

(51) Int. Cl. G06Q 40/00; G06F 7/04

(52) U.S. Cl. 705/32; 340/5.83

(57) ABSTRACT

A privacy-oriented, personally-controlled biometric timekeeping apparatus, method, and system are disclosed. A conventional biometric time clock enrolls users at a centralized device. In my invention, biometric data never leaves the user's personal device that is carried by each employee. Upon hiring, workers are assigned hand-held, portable, mobile biometric devices to carry on their person. In daily use, the user performs biometric self-authentication, after which the personally-carried handheld apparatus sends a “successful biometric authentication” signal to the timekeeping device which is usually a centrally-located timekeeping system. The device is mobile, so workers can biometrically “punch-in” or “punch-out” via personal laptop to the timekeeping system; individually access timekeeping systems installed at worksites; or communicate from vehicles to the timekeeping system.

Improved privacy is facilitated, despite the use of biometrics. “Buddy-punching” (timekeeping fraud, when workers punch-in absent “buddies”) is eliminated with biometric authentication—even though the biometric never leaves the handheld device.

### FIELD OF THE INVENTION

The field of the inventions disclosed is privacy-oriented worker authentication and secure timekeeping. The field of the inventions is also personal biometric privacy. Inventions herein help ensure and improve timekeeping accuracy (actual work-hours, reliably reported) at local, mobile, and remote timekeeping locations. Improved timekeeping equipment and practices help better control costs by reducing fraud. The field also includes flexible timekeeping management and oversight for centralized, distributed, and mobile applications.

### DISCUSSION

### Present State-of-the-Art

Definitions of the terminology used are included at the end of “Specific Examples of Operation”.

The practice of requiring employees to account exactly for their work hours is well-known in the art. Unfortunately, there are many ways that clever but unscrupulous employees can circumvent or subvert reasonable timekeeping objectives of establishing audit trails and keeping honest track of employee hours worked and locations and activities of employee work.

Since the “industrial revolution” began, timekeeping devices have been used. One common device is the time-clock for employee “punch-in and -out” (on-duty and off-duty). Also, newer equipment has been deployed to log employees on and off work, manage employee activities on-the-job (e.g., ID card checking, smartcard log-in, RFID log-in, electric eye log-in, etc.).

There have also been employee-generated tactics to thwart or mislead timekeeping systems such as time-clocks. A widespread infamous dishonest practice is called “buddy punching”. This fraudulent practice is accomplished when an on-site employee punches-in or punches-out his friends who are not present at the time-clock. This common practice facilitates “stealing hours” from employers, because it defrauds timekeeping and thwarts timekeeping/time auditing machines such as time-clocks.

In order to thwart such practices, some time clocks have been fitted with biometric sensors to ensure that the person who is claiming to be reporting to work is actually that person, thereby better ensuring timekeeping accuracy and reliability, and help control costs. This is done, however, by providing fixed biometric time clock stations that restrict employee mobility. It also requires that the employees' fingerprint templates be stored in the stations or in a central database, thereby increasing the risk of identity theft if the database is compromised. It also adds to employee concern that they may be fingerprinted for law-enforcement purposes, causing some valued employees to refuse the fingerprinting process.

It must be noted that there are other biometric timekeeping systems in existence; however, they are not directly comparable to the present inventions. Superficially-comparable biometric timekeeping systems on the market do not offer the privacy and security features of the present invention.

More specifically, the existing state-of-the-art, even when conscious of privacy issues surrounding biometrics, does not provide a means for retaining the biometric data (such as a fingerprint template) on a biometric device carried by a user. Current biometric timekeeping systems require workers to be enrolled into the actual timekeeping station or a central database. By contrast, the present invention retains each enrolled user biometric on the user's carried device and enables user authentication to be performed wherever the device is used.

If this device is used on a computer to log into the timekeeping system, there is no need to preload a program on the computer. Thus, the employee can punch-in or punch-out on any internet connected computer without prior arrangement. After users self-authenticate to their respective devices, a cryptographic signal acknowledging successful authentication of each user, is sent to the timekeeping station on a wireless or wired network without the user's biometric being exposed outside his or her personally-assigned device.

### NECESSITY OF THE INVENTION

Accordingly, there exists latent demand for the present invention. In a modern company, employees are expected to keep accurate records even though they are working on their computers at a client site, at home or at a library in a foreign city. Truckers may punch-in from a restaurant or inside of a truck. Construction workers may punch-in or out from a construction site, or a salesman may report in from a_{.} hotel on the road. My invention is thus necessary in order to help effectuate management best practices and efficiency and effectiveness in timekeeping and in employee management, regardless of the work environment. It is a unique feature of the present invention that allows and improves tracking of employee productivity. The invention allows employee time to be supervised at remote locations where there are no time-clocks and/or where there is a need for accurate time accountability and the employee may not be fully trusted (or able) to keep accurate records of their work hours. Until the advent of the present invention, there has been a lack of non-refutable, authenticated timekeeping that is available wherever the worker is deployed. Until now, there has been no device that has the security property of non-repudiation (comparable to my invention).

### OBJECTS OF THE INVENTION

It is a first primary object of the present invention, to provide the employee with their own personal mobile biometric authentication device to facilitate worker accountability and oversight for both stationary and for mobile work environments.

It is another primary object of the present invention, to defeat “buddy punching”, i.e., the unauthorized punch-in of an employee not present at a time-clock, by a friend (a co-conspiring employee) who is present at the time-clock (who may also attempt to punch-in others as if they were actually “on the job” even when they are not present and in fact they are not on the job.

It is a related object of the present invention, to implement and enforce authenticated timekeeping and employee management best practices by (1) irrefutably authenticating employees, using mobile biometric authentication devices to (2) substantiate employee identity, (3) actual work hours, and to (4) monitor authenticated employee movements, actions, and activities at (5) one or more designated work sites. Note that the property of irrefutability (i.e., non-repudiation) facilitates authenticated record-keeping. Employees cannot refute time-keeping records by claiming records are in error or records were made by another party. Thus, biometrically-authenticated timekeeping also establishes an irrefutable audit trail for employee work history development and documentation, accurate and exact timekeeping on the job and/or simplifies employee time management.

It is another primary object of the invention, to supplant, back-up, (or in the alternate) replace conventional time-clocks, for the purpose of increasing security and accountability in timekeeping and employee management.

It is yet another object of the invention to allow for employee self-enrollment in the USB biometric device without additional assistance.

It is yet also another object of the invention to reduce the company and employee's dependency on needing to remember conventional passwords.

It is another primary object of the invention to protect employee identity privacy, because the invention keeps the fingerprint authentication within the mobile biometric device itself.

### SUMMARY OF THE INVENTION

In one preferred embodiment, the timekeeping database management system of the present invention is adapted for end-user login via a hand-held USB-based biometric authentication device. The USB-based biometric authentication device includes a fingerprint authentication sensor, memory containing the assigned user's fingerprint template, fingerprint recognition algorithm, and processing electronics to carry out the fingerprint authentication.

Each employee is initially assigned and issued a personalized USB device that they personally enroll into. Each employee “self-enrolls”—i.e., they personally initialize and customize their biometric device—by teaching their fingerprints to the biometric sensor.

As an employee starts the workday or arrives at a job site, they simply insert their authentication apparatus . . . typically a USB thumb-drive . . . into the USB interface of any PC. By each employee swiping their finger, the biometric timekeeping verification process is initialized: the employee's start time is noted and recorded in the timekeeping and employee management database. The database compiles the work history of each authenticated employee using time-stamps, at multiple times throughout the day as required (e.g., typically at the beginning of a work day; a move from a base location to a warehouse; a move to loading dock; charging breaks and/or time off in cafeteria; punch back into work after lunch by returning to warehouse; punching out at the end of work day).

The USB-based device can optionally receive a random challenge number and encrypt it to form a reply indicating the result of the authentication process using a unique cryptographic key to encrypt the response message. At the timekeeping center, this response can be decrypted using the same key and examined to see if the user finger matched the template stored in the USB-based device.

Note that other biometric authentication modalities can optionally be deployed for comparable/equifinal timekeeping authentication applications. Note also, however, that ˜70% of biometrics users or prospective users prefer fingerprint sensors for their authentication needs, given the mobility and flexibility of devices such as USB-interface, fingerprint biometrics devices (Frost & Sullivan, Mar. 2, 2010).

Effectively, the timekeeping database management system provides an organized and irrefutable mechanism for monitoring time, location, and certain activities of employees working locally or in remote or distant sites. The timekeeping system can be customized and adapted to continuously monitor timekeeping events, it can report 24×7 hours, and the system can conduct workforce activity accounting for a mobile, stationary, or hybrid workforce.

The fully-automated workforce time management system provides 100% authentication for payroll management, clients, and employees. The company system owner/customer can be assured of the integrity of the process and can confidently charge for billable hours, verify off-site services or telecommuting productivity. This can be accomplished while respecting and protecting personal privacy of employees.

Additional disaggregation is possible, e.g., a database interface can facilitate accounting for employees by crew, department, office, vehicle, weekends, etc. Whenever employees authenticate to their biometric device for timekeeping purposes, records are made of the time of authentication. The total hours worked by any particular employee, class of employee, worksite, etc., can be tabulated and reported in summary or detail form as needed. The data can be easily imported into conventional database products and payroll processing applications.

The greatest benefits of the invention are achieved in very mobile workforces that are required to travel between destinations for work, typically this involves delivery, shipping, and pick-up applications. Notwithstanding, the present invention is particularly useful for stationary workforces because it prevents “buddy punching”, accounts for time and location, special or assigned daily activities requiring contemporaneous tracking, as well as facilitates tracking and sign-in (check in/out) of inbound or outbound deliveries.

### GENERAL THEORY OF OPERATION

In practice, authorized workers (or other end-users) are each assigned a personal authentication device. These individually-assigned authentication devices are hand-held, mobile, portable, AuthentikTime™ biometric fingerprint-readers. The devices are issued to all personnel expected to authenticate to one or more local or remote complementary AuthentikTime™ timekeeping and tracking systems. The hand-held devices are usually assigned to workers by a company system administrator, security officer, or other official. The handheld biometric devices interoperate with all AuthentikTime™ timekeeping systems. Interfaced complementary systems include permanently-installed AuthentikTime™ base stations; USB-equipped mobile laptops; dashboard-based USB equipment; and other USB-interfaced devices requiring worker authentication assurance.

After user self-authentication, and authentication interface to the AuthentikTime™ timekeeping station, user ID verification-related applications are connected onto the AuthentikTime™ website or other designated sites.

More specifically, once assigned an AuthentikTime™ biometric device is assigned, each worker enrolls their own fingerprint(s) into the device. Once a worker and their device are enrolled, the worker can interface timekeeping stations, laptops, and other predetermined devices. Enrolled and authorized workers (or other end-users) authenticate themselves initially (1) to their own device and then (2) subsequently and/or as needed to one or more timekeeping database systems, typically via a USB-PC interface via the internet to the AuthentikTime™ website, and/or via other distributed (e.g., laptop) or central user log-in system interface devices (e.g., this is analogous to and comparable with a “punch-in” card system, only using additional biometric authentication).

Depending on the application and the configuration designed by the customer, there may be multiple different destinations and/or times which the end-user/employee logs into one or more timekeeping system interfaces, in one or more locations, typically usually using their USB-based fingerprint authentication device by first authenticating into it and secondly, logging in whenever and wherever else needed.

Once authenticated to their own assigned device, users are able to irrefutably report to one or more timekeeping system locations and interfaces, either whenever required or whenever they choose or need to securely update the company of their whereabouts and activities.

### SPECIFIC EXAMPLES OF OPERATION

### Delivery Truck Fleet Management

Typically, a customer user must keep track of employees' hours worked on the job, including all reportable aspects of the hours worked. For example, in a hypothetical trucking company application, the company employs (e.g.) 5 (five) truck drivers on various duty shifts. In this hypothetical example, the company owns (e.g.) 3 (three) trucks. The trucks operate on a daily basis with one or more drivers, depending on the job, day of week, and time of day. The hypothetical company ships (e.g.) perishable produce over a multi-state territory, and sends the goods to many different destination sites every week.

It is very important that the trucking company monitors the timely shipment and delivery of the perishable produce. Accordingly, the drivers equipped with their USB fingerprint sensor authentication devices can (1) check into their device at the beginning of the work day, then (2) interface and authenticate with a main timekeeping-USB-interface master device (e.g.) at the company's dispatcher office (a permanently-installed timekeeping device).

After insertion of the USB device into the permanently-installed timekeeping device and authenticating himself by signing in, the truck driver receives a work assignment for the day. At this point (e.g.) truck driver(s) are assigned trucks to commence their work day deliveries. A first driver proceeds to his truck, and (3) uses his already-authenticated USB device, to further authenticate himself to a truck-based dashboard interface fitting which notes that the driver logged onto his truck, at (e.g.) 0800, started the engine without trouble at 0801,then drove out to make a first delivery.

In this example, driver departs (e.g.) the city of Metropolis headed for his first delivery at (e.g.) Green City . . . a drive of 110 miles, which the timekeeping system expects him to reach in ˜2 +/− hours. At the Green City delivery location “Store XYZ”, (4) the driver logs into a loading dock time keeping system. The driver logs into the store's system upon arrival. After about 1 hour—by the end of “hour 3” after his initial login—(5) the driver logs out of the Store XYZ loading dock and then drives to his second delivery stop (e.g.) the town of Smithtown. After reaching the Smithtown location (e.g.) Store ABC, (6) the driver logs into another loading dock time keeping system of the present invention. Upon completing delivery, (7) the driver logs out of the timekeeping system at Store ABC and departs for his next destination, Store MNO, located in Perimeter City. After arriving at the Perimeter City delivery location, (8) the driver logs into the loading dock timekeeping system, makes his delivery, then (9) logs out of that local system. After the last logout, the driver returns to his original location, the Metropolis home base of the trucking company. Upon arrival, (10) the driver logs back in (or out) at his home base system. If the driver is done for the day, he goes home after logging out. Optionally, if he's not done for the day yet, he remains logged in, completes work as required by his shift, and then (11) logs out a final time for the day before going home.

The preferred embodiment teaches that an authenticated user (such as the driver in the above example) updates the timekeeping database at all required junctures. This can be implemented either at every work milestone completion, and/or at every new work location, and/or with new task (or however required) by authenticating and interacting with a computer interface to evidence the driver's work task, location, time, etc.

The system can also be interfaced with a company message center, operator, receptionist, dispatcher, human resources, financial department, supply and inventory department, etc., or any company office which tracks employee movements, locations, reportable activities, or deliverables. Additionally, the user company can interface a database management system for timekeeping of their enrolled users, with inventory, finance, security, and/or other interfaces.

### TERMINOLOGY

For purposes of this application, “timekeeping” refers to accounting for and adding up totals of a worker's hours across specified accounting periods (e.g., hours, days, weeks, etc.). The term also refers to the hours a worker dedicates to assigned project(s). The term as used herein also means timekeeping across assigned projects, destinations, and locations. Ideally, employee timekeeping is most accurate, reliable, and easiest to corroborate when its audit trail is non-reputable and irrefutable.

The term “employee management” refers to mobile activities of workers who are required to go to one or more specified or assigned locations or travel stops. The phrase “timekeeping and employee management” refers to improving and ensuring the availability of a fully and properly documented audit trail. This is effectuated by simultaneously tracking worker's hours on a job (i.e., proven to be “punched in”); plus exactly where a worker is working (or has travelled to/or is “in-transit” to); and optionally, what project or task the worker has been working on.

The term “privacy-oriented biometrics” refers to privacy-oriented biometric authentication techniques. Such techniques include can optionally also including cryptographic techniques which help eliminate or reduce identity theft, timekeeping fraud, and “buddy punching” (when one worker punches-in another worker who's “not present”). The techniques of the present invention additionally reserve privacy of personal biometric fingerprint data of each worker or employee, to their own personal and private biometric authentication device.

### DESCRIPTION OF FIGURES & REFERENCE NUMERALS

### Overview of Figures

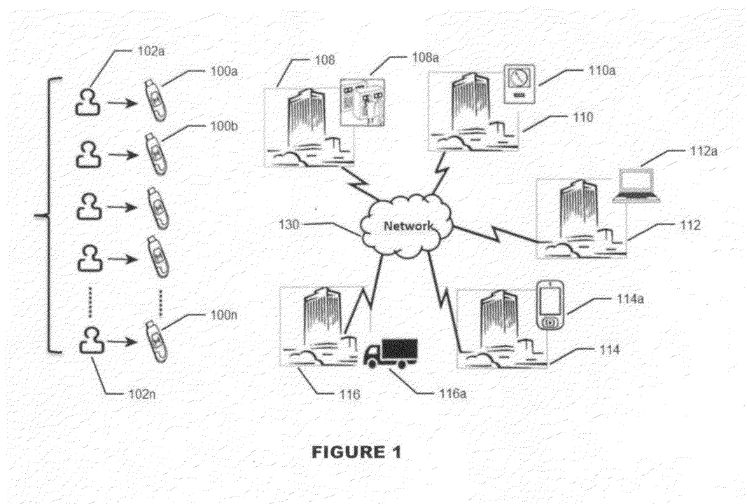

FIG. 1, AuthentikTime™ Timekeeping System Overview

FIG. 2, Biometric USB “self-authentication” device is carried by each enrolled worker

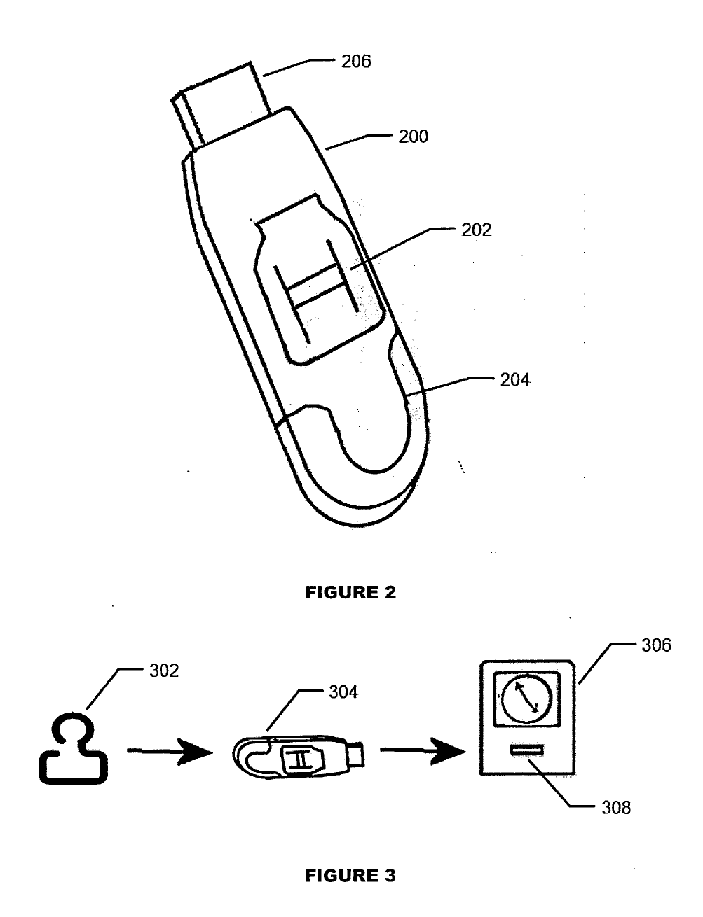

FIG. 3, Driver 302 self-authenticates; re-authenticates via slot 308 at Gate Station 306

### REFERENCE NUMERALS

FIG. 1, AuthentikTime™ Timekeeping System Overview (tracks worker time & attendance)
100a-n Individually-assigned biometric authentication devices 100a, 100b, 100c . . . 100n
102a-n Enrollments: Worker 102a/enrolled in 100a; 102b/enrolled 100b . . . 102n/enrolled 100n
108 Main Building 108: building entrance; any enrolled workers can log-in (see also 108a)
108a Gate Station 108a: main building entrance; connects to data center/repository/databases
110 Building 110 (remote location) equipped with Gate Station 110a (time-clock log-in only)
112 Building 112 (remote location) equipped with Gate Station 110a (fixed & mobile log-ins)
114 Building 114 (remote location) using PCs, smartphones 114a (fixed & mobile log-ins)
116 Building 116 (plus motor pool); Truck-based Station 116a (fixed, mobile & vehicle log-ins)
116a Truck 116a/assigned to Motor Pool at building 116; other cars/trucks available
130 Internet: local & remote networks; uses Internet and/or other network resources/links

FIG. 2, Biometric USB device carried by workers, for biometric self-authentication
200 Biometric Fingerprint Authentication Device assigned to each worker
202 Fingerprint Swipe Sensor for biometrically self-authenticating each enrolled worker
204 GPS-communicator interface (optional; uses embedded and/or wraparound antenna)
206 USB male connector inserts into USB female fitting on timekeeping station

FIG. 3, Driver 302 self-authenticates; then further authenticates at Gate Station 306
302 Authenticated Driver 302 uses device 304; punches-in via machine 306 via port 308
304 Device 304
306 Permanently-installed (fixed) timekeeping station 306
308 Female USB interface for insertion of device 304(or other specified fitting/not shown)

### DETAILED DISCUSSION OF THE INVENTION

FIG. 1 depicts the overall system of the AuthentikTime™ apparatus, method, and system of the present invention. The timekeeping system of the invention comprises:
One or more biometric authentication devices (individually- and/or multiply-assigned);
One or more pre-enrolled workers (drivers, employees, etc.) assigned to use the system;
One or more AuthentikTime™ timekeeping interface devices deployed at timekeeping sites visited by workers, comprising:
   (i) fixed-site (permanently-installed) timekeeping “Gate Stations”; and/or
   (ii) mobile-site (permanently-installed) timekeeping stations, e.g., deployed in vehicle dashboards (stations that move when the vehicle moves); and/or
   (iii) user-based (portable-site) timekeeping stations (PCs, laptops, notebooks, PDAs, smartphones, etc.) having biometric sensor devices—either “factory-installed”, retro-fitted, and/or deployed via USB interfaces that accept removable USB devices including biometric devices carried by enrolled workers (employees, drivers, etc.) compatible with the AuthentikTime™ system.
One or more fixed, “non-mobile” and/or “mobile” data repositories, data centers, or mobile networkable data storage interfaces connectable to database(s) adapted for interconnection to timekeeping gate station(s); e.g., having storage media for storing, tracking, monitoring, and archiving worker and device authentication data (further comprising data disks; EEPROMs, and/or other inter-connectable storage media)
Network (carrier) resources and network connection means for communicating between and among centralized and/or distributed timekeeping system(s); e.g., further comprising one or more of wired-connection(s), wireless connection(s), internet connection(s), and the like
Optionally, mobile controlled assets, (different from animate “employee assets”) comprising “inanimate but movable assets”, e.g., autos, vehicles, other movable, valuable (“tracked”) assets whose movements are tracked, monitored, controlled, archived, and subject to oversight by the system;

Referring again to FIG. 1, biometric devices [100a, 100b, 100c . . . 100n] are shown. Devices are distributed to employees, e.g., when employees are hired and/or enrolled for timekeeping purposes. Biometric devices are individually-assigned (or can be multiply-assigned). (See FIG. 2 for further detail on biometric devices.) Devices [100a . . . 100n] are used to biometrically authenticate each employee to whom at least one device is assigned.

To be more specific, workers assigned one or more biometric devices [100a . . . 100n], are persons who biometrically self-authenticate to such device(s) whenever necessary (e.g., for security, policy, timekeeping, location logging, task start or completion, or other purposes). Here, such persons comprise the company's enrolled workers, drivers, contractors, and/or consultants, persons [102a, 102b . . . 102n]. These people can be any enrolled employee: e.g., on- or off-premises workers (local, remote, or in-transit); drivers or personnel who are driving as part of their job (truck, car, or assigned-task driver), a consultant or contractor, or any other person others whose work time periods, work locations, and work destinations are subject to oversight or timekeeping by the company.

Referring yet again to FIG. 1, company local and/or remote destination buildings 108, 110, 112, 114, and 116 are shown. Building 116 is (e.g.) a building with a motor pool site where company cars and/or trucks [116a, 116b . . . 116n] are parked and located ( ). Each company building and/or monitored remote destination or building is equipped with at least one AuthentikTime Gate Station, in accordance with policies/needs/specifications of system owners/administrators/security.

When enrolled and monitored workers enter any building equipped with a Gate Station, after first authenticating themselves to their own assigned device, they then use their device to authenticate (and log-into) the local AuthentikTime™ timekeeping Gate Station. For simplicity sake, as shown here, time and location monitoring in each building is accomplished by local Gate Stations [108a, 110a, 112a, 114a and 116a] which are installed or are made operable at fixed or mobile or in-transit locations within buildings 108, 110, 112, 114, and 116 and/or within cars and trucks equipped with authentication interfaces of the present invention which are portable and/or mobile. Note also that employees, drivers, workers, contractors, and consultants proceed either to their own building and/or other assigned building(s) where they log in. The workers can also be required to log-in to “movable asset(s)” during the course of any work day. Truck drivers, for illustration here, log-in to assigned vehicles [116a . . . 116n].

FIG. 2 depicts the biometrically-authenticating USB interface device carried by each worker. The unit is used for (1) biometric self-authentication and (2) time- and location keeping data generation at an AuthentikTime™ timekeeping gate station. Device 200 is a close-up of one individually-assigned device such as [100a . . . 100n].

Detail shown on Device 200 includes fingerprint swipe sensor 202, for biometric enrollment and subsequent self-authentication of a worker or other designee. Optional antenna 204 (an external wraparound antenna) is also shown—it can be used for wireless communication. Note, as a counterpoint, an internal component-based antenna can also be specified if contactless communication features are implemented. Here, antenna 204 includes a GPS-communicating antenna comprised within (one preferred product option).

USB male connector 206 can be inserted into a USB female fitting (not shown) on gate station(s) so equipped. Conversely, a user device could have a female USB interface for a male port interface (not shown).

Referring now to FIG. 3, Driver 302 self-authenticates. Driver 302 enters the worksite after (1) self-authenticating to his or her device, and then (2) authenticating to Gate Station 306 via interface 308. In addition (or alternatively), Driver 302 can authenticate into any mobile asset such as vehicles [116a . . . 116n]. Otherwise stated, any authorized and pre-enrolled worker, driver, consultant, contractor, etc., can first self-authenticate and next additionally authenticate and log-in to any gate station—be it a fixed, permanently-installed building-based gate station such as [108a, 110a, 112a, 114a, and 120a] AND/OR a movable, installed gate station disposed (not shown) within mobile assets [104A . . . 104N] of the company. Alternatively again, an enrolled employee or designee can first self-authenticate and subsequently authenticate into a PC, laptop, PDA, smart-phone, or other computing device adapted to include AuthentikTime™ timekeeping interface means.

FIG. 4, Worker “A” signs onto Truck 1234; starts ignition; delivers goods to remote worksite. Picture could show a truck first loading at a first site . . . proceeding from the start site to a destination point, also show a clock (hour and minute hands) at each location, and/or show a GPS satellite and/or radio connection. (FIG. 4 to be shown in Regular Patent Application forthcoming.) (FIG. 4 to be shown in Regular Patent Application forthcoming.)

FIG. 5, Close-up of the display screen(s) of an AuthentikTime™ timekeeping Gate Station (whether permanently-installed at a non-mobile fixed site, permanently-installed in a mobile but dashboard-installed site, or in a highly-mobile device such as a laptop, PC, PDA, net-book, smart-phone, or other interfaceable device used for timekeeping and positive control. (FIG. 5 to be shown in Regular Patent Application forthcoming.) (FIG. 5 to be shown in Regular Patent Application forthcoming.)

I claim:

1. An improved privacy-oriented biometric apparatus adapted for ensuring accurate tracking of worker attendance, time at work, time on each task, status of each task, and location of each task while maintaining worker biometric privacy, comprising said biometric apparatus which retains at least one worker biometric completely therewithin to provide privacy, wherein said biometric apparatus is further adapted for worker self-authentication and further comprises means for initiating and exchanging messages with at least one external device comprising a timekeeping station to confirm successful worker self-authentication by said biometric apparatus.

2. The biometric apparatus of claim 1, further adapted for verifying and tracking biometrically-authenticated workers' usage and deployment of assets, asset movement by biometrically-authenticated workers, and asset last-known location data.

3. The biometric apparatus of claim 1, further comprising an enclosure housing an electronic circuit comprising at least one biometric sensor, at least one processor with a memory to retain and execute at least one software application, a communications subsystem including data input/output interfaces and buffers, and a power subsystem.

4. The apparatus of claim 3, wherein said at least one software application further comprises means for biometrically verifying worker identity after worker self-authentication by an enrolled authorized worker.

5. The apparatus of claim 3, wherein said communications subsystem further comprises at least one transceiver means for relaying the successful result of worker self-authentication to at least one external device comprising at least one timekeeping station, said at least one transceiver also having the capacity to respond to received polls, selects, data, messages, file uploads and downloads, and other transmissions from said at least one external device.

6. The biometric authentication apparatus of claim 1, wherein said apparatus further comprises a mobile, portable, biometric apparatus executing proprietary software, wherein said apparatus is assigned to at least one enrolled worker and wherein said apparatus communicates with at least one external device comprising at least one timekeeping station.

7. The apparatus of claim 6, wherein said apparatus communicates to said at least one external device by at least one of manually, automatically, or a combination of manually or automatically.

8. The apparatus of claim 1, wherein said at least one external device comprises a proprietary “AuthentikTime™” timekeeping station for interface with a proprietary “AuthentikTime™” apparatus.

9. The apparatus of claim 8, wherein said timekeeping station is further adapted for at least one of interactive communications with a proprietary website, including uploads and downloads; receiving and responding to store-and-forward communications from and to said website; and receiving polls and selects from said website and responding thereto.

10. The apparatus of claim 1, wherein said timekeeping station is further adapted for communication with and exportation to additional external devices executing timekeeping software applications including payroll calculation software, spreadsheet software, asset tracking and management software.

11. The apparatus of claim 1, wherein said biometric sensor comprises at least one from the group of a fingerprint sensor, a hand geometry sensor, a heartbeat sensor, and an “aliveness” temperature sensor.

12. The apparatus of claim 1, wherein said communications interface comprises at least one of a male USB fitting adapted for physical insertion into said at least one external device, a female USB fitting adapted for insertion of a male USB fitting of said external device, a wire-connection means for connecting said apparatus directly into said external device, and a wireless transceiver means for wirelessly communicating to said external device.

13. The apparatus of claim 1, wherein said at least one external device further comprises a first external wireless transceiver for wirelessly communicating with a second external wireless transceiver resident on at least one host system comprising an additional external device.

14. The apparatus of claim 1, further adapted for sending and receiving cryptographically-secured data messages after cryptographically encapsulating said data messages into secure data messages to effectuate secure data transmission including sending said secure data messages to said at least one external device only after completion of biometric fingerprint authentication by a worker self-authentication.

15. The apparatus of claim 1, wherein said apparatus for worker self-authentication communicates with said at least one external device comprising an “AuthentikTime™” timekeeping station adapted for communicating with said apparatus and further communicating with an “AuthentikTime™” website further adapted to communicate with at least one of laptop computer and a host computer.

16. A method for automating timekeeping and employee management by at least one user-authenticating apparatus for establishing the time and place of authentication of at least one user by at least one said apparatus and by at least one interface apparatus for additional timekeeping and employee management, comprising the steps of:
a. establishing a system adapted to improve timekeeping and location tracking of workers and further adapted to protect biometric privacy of enrolled users;
b. assigning privacy-oriented self-authenticating biometric apparatuses to at least one of a worker and a user;
c. enrolling at least one worker into at least one assigned biometric apparatus;
d. admitting each enrolled worker in a location which allows them to interface their said at least one assigned biometric apparatus to interface and operate with at least one AuthentikTime gate station;
e. logging in and/or out of at least one of: an AuthentikTime™ gate station; at least one of a laptop and a computer and a central host computer communicating with an AuthentikTime™ website; an AuthentikTime™ remote worksite communicating with an AuthentikTime™ website; and a vehicle or other moving asset with an affixed AuthentikTime™ dashboard interface and further connected with an AuthentikTime™ website.

17. A method for improving accuracy of timekeeping and tracking of workers and for improving the monitoring and tracking of assets moved by self-authenticated workers, comprising the steps of:
a. deploying at least one timekeeping and monitoring station for enrolling and authorizing worker log-in by means of at least one biometric device;
b. assigning said at least one biometric device to at least one worker;
c. enrolling each worker into said at least one assigned biometric apparatus;
d. copying a limited amount of biometric authentication data associated with each enrolled worker and saving said limited biometric authentication data for later comparison and subsequent authentication of at least one worker;
e. Instructing said at least one worker to self-authenticate to their assigned device and to further authenticate themselves and their authentication device to said at least one timekeeping and monitoring station.

18. A system for authenticating workplace timekeeping records, tracking worker time, tracking worker location, and tracking worksite activities and assets using at least one worker management database for establishing an irrefutable audit trail.

19. A system adapted for improving accuracy of timekeeping and location tracking of workers, and further adapted for improving the monitoring of movable assets, comprising:
a. at least one enrolled human user of the system of the invention comprising at least one of a worker, a consultant, a vendor, a contractor;
b. at least one of a general purpose computer and a laptop, a PDA, a Blackberry, an Apple (or other computing machinery capable of storing timekeeping and location data about said at least one worker), and additionally capable of interconnecting with at least one timekeeping gate station website and further capable of sending and receiving messages about the self-authentication status of any of said at least one of a user and a worker to and from said website;
c. at least one biometric apparatus carried by said at least one of a user and a worker, said apparatus being implemented for self-authentication by said at least one of a user and a worker;
d. at least one of a data center and a data repository and a database and a timekeeping gate station for receiving, storing, retrieving, and summarizing data relating to said at least one worker's timekeeping and location while on the job by means of a record of successful self-authentication.

20. The system of claim 19, wherein said gate station website is a proprietary “AuthentikTime™” website.
